(19) United States
(12) Patent Application Publication
(10) Pub. No.: US 2012/0179385 A1
(43) Pub. Date: Jul. 12, 2012

(54) TRAJECTORY CREATING APPARATUS

(75) Inventor: Fumio NAGASHIMA, Kawasaki (JP)

(73) Assignee: FUJITSU LIMITED, Kawasaki (JP)

(21) Appl. No.: 13/425,809

(22) Filed: Mar. 21, 2012

Related U.S. Application Data
(63) Continuation of application No. PCT/JP2009/066695, filed on Sep. 25, 2009.

(51) Int. Cl. G06F 19/00

(52) U.S. Cl. 702/19

(57) ABSTRACT

A trajectory creating unit uses sensor values obtained from an acceleration sensor and an angular velocity sensor that are attached to a predetermined region of a person's body and creates a motion trajectory of the predetermined region. The trajectory creating unit separately creates a motion trajectory of a predetermined region of the person's body obtained between the starting motion of the series of the movements and an impact motion, and a motion trajectory of the predetermined region of the body obtained between the impact motion and the end motion of the movements.

### CROSS-REFERENCE TO RELATED APPLICATION

This application is a continuation of International Application No. PCT/JP2009/066695, filed on Sep. 25, 2009, the entire contents of which are incorporated herein by reference.

### FIELD

The embodiments discussed herein are directed to a trajectory creating apparatus and a computer-readable storage medium storing a trajectory creating program.

### BACKGROUND

In recent years, there has been proposed a technology for creating a motion trajectory of a region of a person's body by attaching an acceleration sensor and an angular velocity sensor to the region of the body and then using each sensor value obtained from the acceleration sensor and the angular velocity sensor (see, for example, Koichi Sagawa, Yasuko Moriyama, Toshiaki Tsukamoto, Izumi Kondo, “3D measurement of forearm movement during pitching utilizing body-mounted sensor”, The Society of Instrument and Control Engineers, 216th research conference, Reference number 216-4, Jun. 22, 2004). Furthermore, in recent years, mobile phones that have a pedometer function by installing acceleration sensors therein have been developed.

However, in the above-described technology, if a sensor, which is attached to the body, receives a sudden impact during a series of movements, an error occurs in the sensor value that is obtained from the sensor. Accordingly, there is a problem in that it is difficult to accurately reproduce the motion trajectory.

### SUMMARY

According to an aspect of an embodiment of the invention, a trajectory creating apparatus includes a trajectory creating unit. The trajectory creating unit separately creates, if a series of movements has impact motion that generates a predetermined impact, by using sensor values obtained from an acceleration sensor and an angular velocity sensor that are attached to a predetermined region of a person's body, a motion trajectory of the predetermined region of the person's body that is obtained between the starting motion of the series of the movements and the impact motion and a motion trajectory of the predetermined region of the person's body obtained between the impact motion and the end motion of the series of the movements.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram illustrating a trajectory creating apparatus according to a first embodiment;

FIG. 2 is a schematic diagram illustrating the configuration of a mobile phone according to a second embodiment;

FIG. 3 is a schematic diagram illustrating an example of a display according to the second embodiment;

FIG. 4 is a schematic diagram illustrating an example of a display according to the second embodiment;

FIG. 5 is a schematic diagram illustrating an example of a display of a motion trajectory of a waist according to the second embodiment;

FIG. 6 is a flowchart illustrating an exemplary flow of a process performed by a trajectory creating unit according to the second embodiment;

FIG. 7 is a flowchart illustrating an exemplary flow of a process performed by the trajectory creating unit according to the second embodiment;

FIG. 8 is a flowchart illustrating an exemplary flow of a process performed by the trajectory creating unit according to the second embodiment; and

FIG. 9 is a block diagram illustrating a computer that executes a trajectory creating program.

### DESCRIPTION OF EMBODIMENTS

Preferred embodiments of a trajectory creating program and a trajectory creating apparatus disclosed in the present invention will be described in detail below with reference to the accompanying drawings. The present invention is not limited to the embodiments that are described below as part of the embodiments of the trajectory creating program and the trajectory creating apparatus.

### [a] First Embodiment

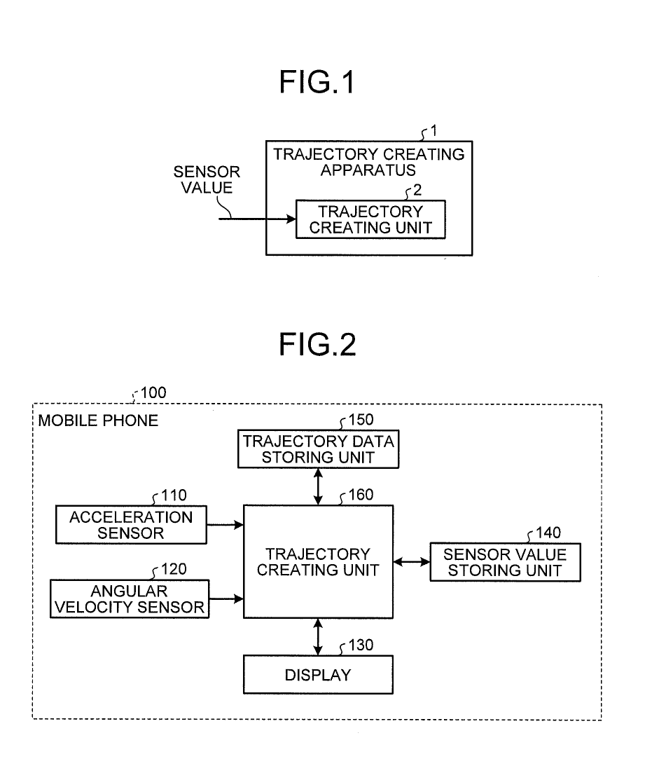

FIG. 1 is a schematic diagram illustrating a trajectory creating apparatus according to a first embodiment. As illustrated in FIG. 1, a trajectory creating apparatus 1 according to the first embodiment includes a trajectory creating unit 2.

If a series of movements has impact motion that generates a predetermined impact, the trajectory creating unit 2 creates a motion trajectory of a predetermined region by using sensor values obtained from an acceleration sensor and an angular velocity sensor that are attached to a predetermined region of a person's body. For example, the trajectory creating unit 2 separately creates a motion trajectory of the predetermined region of the body that is obtained between the starting motion of a series of movements and the impact motion and also a motion trajectory of the predetermined region of the body obtained between the impact motion and the end motion of the series of movements.

Specifically, the trajectory creating unit 2 according to the first embodiment creates a motion trajectory of a predetermined region of a person's body by dividing the series of movements into two stages, i.e., before and after the impact motion. Accordingly, it is possible to take into consideration the impact motion that affects the trajectory of the predetermined region of the body, thus reproducing the trajectory of the series of movements more accurately.

### [b] Second Embodiment

### Configuration of the Second Embodiment

In a second embodiment, a mobile phone is used as an example of the trajectory creating apparatus disclosed in the present invention; however, the mobile phone is only an example. Any small information processing apparatus that can be attached to a person's body may also be used. Furthermore, in the following description, a case will be described in which the motion trajectory of the waist is created when a golf swing is performed by attaching a mobile phone according to the second embodiment to the waist.

FIG. 2 is a schematic diagram illustrating the configuration of a mobile phone according to a second embodiment. As illustrated in FIG. 2, a mobile phone 100 according to the second embodiment includes an acceleration sensor 110, an angular velocity sensor 120, a display 130, a sensor value storing unit 140, a trajectory data storing unit 150, and a trajectory creating unit 160.

If the trajectory creating unit 160 starts a process, which will be described later, the acceleration sensor 110 continuously measures the acceleration of the waist to which the mobile phone 100 is attached at a time interval (e.g., a 0.2-second interval) that is set as a default. Then, the acceleration sensor 110 transmits the measured acceleration sensor values (e.g., a voltage value) to the trajectory creating unit 160, which will be described later.

Furthermore, if the trajectory creating unit 160 starts a process, which will be described later, the angular velocity sensor 120 continuously measures an angular velocity of the waist to which the mobile phone 100 is attached at a time interval (e.g., a 0.2-second interval) that is set as a default and transmits the measured angular velocity sensor values (e.g., voltage values) to the trajectory creating unit 160, which will be described later. The acceleration sensor 110 and the angular velocity sensor 120 perform the measurement in synchronized timing.

The display 130 displays the motion trajectory of the waist created by the trajectory creating unit 160 in a manner in which a user can see it. Furthermore, the display 130 displays menu information when starting to create the motion trajectory of the waist at the time of golf swing. The display 130 also displays information containing a list of the past motion trajectory of the waist stored in the trajectory data storing unit 150, which will be described later.

The sensor value storing unit 140 stores therein acceleration sensor values measured by the acceleration sensor 110 and angular velocity sensor values measured by the angular velocity sensor 120 by associating them on the basis of the same measurement time.

The trajectory data storing unit 150 stores therein, in an associated manner, data related to the motion trajectory of the waist created by the trajectory creating unit 160 and the date and time at which the motion trajectory is created.

The sensor value storing unit 140 and the trajectory data storing unit 150 are, for example, a semiconductor memory device, such as a random access memory (RAM) and a flash memory, or a storage device, such as a hard disk and an optical disk.

By using the acceleration sensor values measured by the acceleration sensor 110 and the angular velocity sensor values measured by the angular velocity sensor 120, the trajectory creating unit 160 creates the motion trajectory of the waist obtained when a golf swing is performed by attaching the mobile phone 100 to the waist.

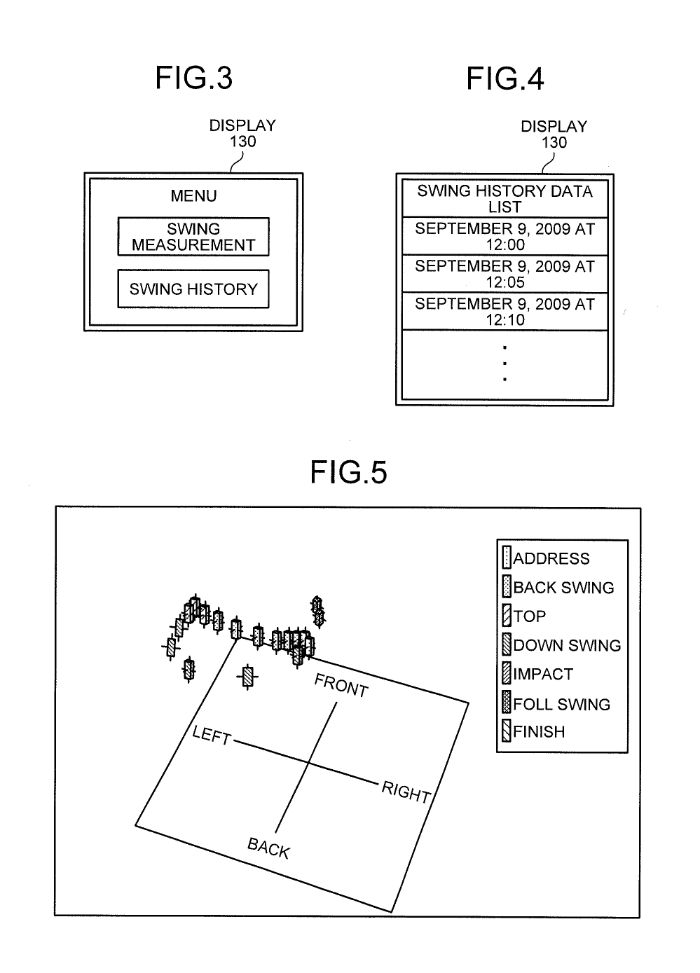

FIG. 3 is a schematic diagram illustrating an example of a display according to the second embodiment. FIG. 3 illustrates the display 130 on which a menu screen having selection items of “swing measurement” and “swing history” is displayed. The “swing measurement” is an item that is selected by a user if the user wants to create the motion trajectory of the waist when the user performs a golf swing. The “swing history” is an item that is selected by a user if the user wants to browse the list of the motion trajectory of the waist stored in the trajectory data storing unit 150.

The trajectory creating unit 160 outputs, for example, menu screen illustrated in FIG. 3 to the display 130 in accordance with the operation performed by a user. Then, if an input of the “swing history” is received, the trajectory creating unit 160 outputs, for example, as illustrated in FIG. 4, the list of the motion trajectory of the waist stored in the trajectory data storing unit 150 to the display 130. FIG. 4 is a schematic diagram illustrating an example of a display according to the second embodiment. In FIG. 4, the list of the date and time at which the motion trajectory of the waist is created is displayed in time series on the display 130 as the list of swing history data. For example, if an input of “Sep. 9, 2009 at 12:00” is received, the trajectory creating unit 160 reads, from the trajectory data storing unit 150, data on the motion history of the waist associated with the selected date and time and outputs it to the display 130.

Furthermore, if an input of the “swing measurement” is received, the trajectory creating unit 160 starts creating the motion trajectory of the waist obtained when a golf swing is performed by attaching the mobile phone 100 to the waist. The trajectory creating unit 160 performs the operation on the assumption that a certain offset acceleration is generated during the golf swing. The offset acceleration mentioned here means a certain error with respect to a true value of the acceleration. The trajectory creating unit 160 performs a process described below in accordance with two conditions, i.e., a boundary condition 1: “the waist position at the time of the starting of the swing is the same as that of an impact” and a boundary condition 2: “the velocity of the waist at the end of the swing is zero”.

For example, if an input of the “swing measurement” is received, the trajectory creating unit 160 sets a waist posture matrix (R) and an initial condition (a vector of the waist position: p=0 and a vector of the velocity of the waist: v=0). The waist posture matrix (R) and the initial condition (a vector of the waist position: p=0 and a vector of the velocity of the waist: v=0) are given by Equations (1), (2), and (3) below:

$$\begin{matrix}R = ( \begin{matrix}1 , 0 , 0 \\ 0 , 1 , 0 \\ 0 , 0 , 1\end{matrix} ) & ( 1 ) \\ p = ( 0 , 0 , 0 ) & ( 2 ) \\ v = ( 0 , 0 , 0 ) & ( 3 )\end{matrix}$$

After setting the waist posture matrix (R) and the initial condition (p=0, v=0), the trajectory creating unit 160 obtains, from the sensor value storing unit 140, all of the acceleration sensor values (α₀) and the angular velocity sensor values (ω₀) measured from the swing motion. Then, from among the obtained acceleration sensor values and the angular velocity sensor values, the trajectory creating unit 160 extracts a combination of the acceleration sensor value and the angular velocity sensor value that are measured at the same time and converts the extracted acceleration sensor value and the angular velocity sensor value to the absolute coordinates (α and ω). Furthermore, by performing the calculation illustrated by Equations (4) and (5), the acceleration sensor value and the angular velocity sensor value are converted to the absolute coordinates.

α=Rα₀ (4)

ω=Rω₀ (5)

When the conversion to the absolute coordinates is completed, the trajectory creating unit 160 substitutes the absolute coordinates into Equations (6) to (10) below and calculates, in accordance with the boundary conditions described above, the positions and the postures (R and P) by performing one-step numerical integration. From the numerical integration, the x-component row vector (Rₓ) of the waist posture matrix, the y-component row vector (R_{y}) of the waist posture matrix, the z-component row vector (R_{z}) of the waist posture matrix, the position vector (p) of the waist, and a vector (v) of the velocity of the waist are calculated.

$$\begin{matrix}\frac{d {R}_{x}}{d t} = ω \times {R}_{x} & ( 6 ) \\ \frac{d {R}_{y}}{d t} = ω \times {R}_{y} & ( 7 ) \\ \frac{d {R}_{z}}{d t} = ω \times {R}_{z} & ( 8 ) \\ \frac{d v}{d t} = α & ( 9 ) \\ \frac{d p}{d t} = v & ( 10 )\end{matrix}$$

After calculating the positions and the postures, the trajectory creating unit 160 determines whether calculation of all of the positions and the postures of the acceleration sensor values (α₀) and the angular velocity sensor values (ω₀) measured from the swing motion has been completed. If the determination result is that the calculation of all of the positions and the postures of the acceleration sensor values and the angular velocity sensor values measured from the swing motion has not been completed, the trajectory creating unit 160 performs the following process. Namely, by performing a process using Equations (4) to (10), the trajectory creating unit 160 calculates the positions and the postures of the acceleration sensor values and the angular velocity sensor values that have not been calculated.

In contrast, if the calculation of all of the positions and the postures of the acceleration sensor values and the angular velocity sensor values measured from the swing motion has been completed, the trajectory creating unit 160 performs the following process. Namely, by using Equation (11) illustrated below, the trajectory creating unit 160 calculates offset acceleration 1 between the starting of the golf swing and an impact. Equation (11) is used to derive the offset acceleration 1 in accordance with the boundary condition 1 described above, where, from among the values of p obtained from the integration described above, a value of p associated with the impact is substituted into p in Equation (11).

$$α = \frac{2 p}{{t}^{2}} \qquad ( 11 )$$

After calculating the offset acceleration 1, the trajectory creating unit 160 corrects the acceleration sensor value using the offset acceleration 1; performs the same process as that described above; and calculates the position and the posture obtained between the starting of the golf swing and the moment of the impact.

Specifically, the trajectory creating unit 160 obtains, from the sensor value storing unit 140, all of the acceleration sensor values and the angular velocity sensor values measured from the swing motion. Then, from among the obtained acceleration sensor values and the angular velocity sensor values, the trajectory creating unit 160 extracts a combination of the acceleration sensor value and the angular velocity sensor value measured at the same time. Then, the trajectory creating unit 160 subtracts the offset acceleration 1 from the extracted acceleration sensor value and converts, to the absolute coordinates (α and ω) by using Equations (4) and (5) described above, the acceleration sensor value, which is obtained by subtracting the offset acceleration 1 from the extracted acceleration sensor value, and the angular velocity sensor value. After converting the values to the absolute coordinates, the trajectory creating unit 160 substitutes the absolute coordinates into Equations (6) to (10); performs one-step numerical integration in accordance with the boundary condition described above; and calculates the position and the posture.

After calculating the position and the posture, the trajectory creating unit 160 determines whether the calculation of all of the positions and the postures of the acceleration sensor values and the angular velocity sensor values measured from the swing motion has been completed. If the determination result is that the calculation of all of the positions and the postures of the acceleration sensor values and the angular velocity sensor values measured from the swing motion has not been completed, the trajectory creating unit 160 performs the following process. Namely, by performing a process using Equations (4) to (10), the trajectory creating unit 160 subtracts the offset acceleration 1 from the acceleration sensor value that has not been calculated and calculates the position and the posture of the acceleration sensor value and the angular velocity sensor value obtained by subtracting the offset acceleration 1.

In contrast, if the calculation of all of the positions and postures of the acceleration sensor values and the angular velocity sensor values measured from the swing motion has been completed, the trajectory creating unit 160 performs the following process. Namely, by using Equation (12) below, the trajectory creating unit 160 calculates offset acceleration 2 between the moment of the impact of the golf swing and the end of the swing.

Equation (12) is used to derive the offset acceleration 2 in accordance with the boundary condition 2 described above. Specifically, the trajectory creating unit 160 substitutes, into vₛ in Equation (12), a value obtained by subtracting a value of v associated with the impact from a value of v associated with the end of the swing from among the values of v obtained from the integration after calculating the offset acceleration 1. Furthermore, the trajectory creating unit 160 substitutes the time period between the moment of the impact and the end of the swing into t in Equation (12).

In the second embodiment, the operation is performed on the assumption that a certain offset acceleration is generated during the golf swing. Accordingly, a certain velocity in accordance with the offset acceleration is derived as a velocity of a waist associated with the end of the swing. By focusing attention on this point, Equation (12) is derived on the basis of the “boundary condition 2: the velocity of the waist at the end of the swing is zero”.

$$α = \frac{{v}_{s}}{t} \qquad ( 12 )$$

After calculating the offset acceleration 2, the trajectory creating unit 160 performs the same process as that described above and calculates the positions and the postures obtained between the moment of the impact and the end of the swing that are corrected in accordance with the offset acceleration 2.

Specifically, the trajectory creating unit 160 obtains, from the sensor value storing unit 140, all of the acceleration sensor values and the angular velocity sensor values measured from the swing motion. Then, the trajectory creating unit 160 subtracts the offset acceleration 1 and 2 from each of the acceleration sensor values from the impact to the end of the swing. By using Equations (4) and (5), the trajectory creating unit 160 converts, to the absolute coordinates, each of the acceleration sensor values, which is obtained by subtracting the offset acceleration 1 and 2, and each of the angular velocity sensor values. After converting the values to the absolute coordinates, the trajectory creating unit 160 substitutes the absolute coordinates into Equations (6) to (10); performs one-step numerical integration in accordance with the boundary conditions 1 and 2 described above; and calculates the positions and the postures.

After calculating the positions and postures, by combining the positions and the postures, which are obtained between the starting of the swing and the moment of the impact, and the positions and the postures, which is obtained between the moment of the impact and the end of the swing, the trajectory creating unit 160 creates trajectory data indicating a series of the movements of the waist in the swing motion. Then, as illustrated in FIG. 5, the trajectory creating unit 160 outputs the created trajectory data to the display 130. FIG. 5 is a schematic diagram illustrating an example of a display of a motion trajectory of the waist according to the second embodiment. Furthermore, the trajectory creating unit 160 stores the created trajectory data in the trajectory data storing unit 150.

The trajectory creating unit 160 is, for example, an integrated circuit, such as an application specific integrated circuit (ASIC) and a field programmable gate array (FPGA), or an electronic circuit, such as a central processing unit (CPU) and a micro processing unit (MPU).

### Process Performed in the Second Embodiment

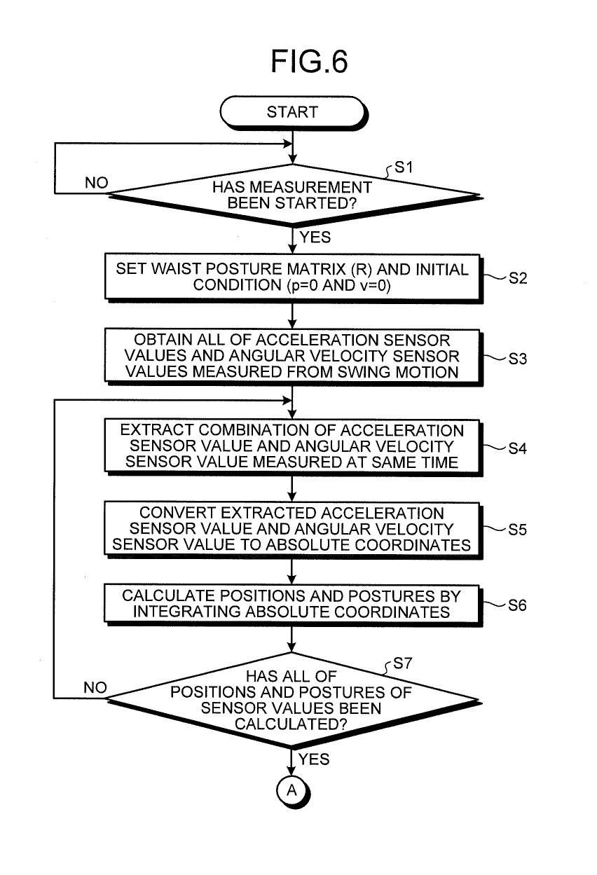

FIGS. 6 to 8 are flowcharts each illustrating the flow of a process performed by a trajectory creating unit according to the second embodiment. As illustrated in FIG. 6, the trajectory creating unit 160 waits the starting of the swing measurement related to the creation of the motion trajectory of the waist that is obtained when a golf swing is performed (Step S1). Then, if an input of, for example, the “swing measurement” is received, the trajectory creating unit 160 starts the measurement (Yes at Step S1) and sets the waist posture matrix (R) and the initial condition (a vector of the waist position: p=0 and a vector of the velocity of the waist: v=0) (Step S2).

After setting the waist posture matrix (R) and the initial condition (p=0 and v=0), the trajectory creating unit 160 obtains, from the sensor value storing unit 140, all of the acceleration sensor values (α₀) and the angular velocity sensor values (ω₀) measured from the swing motion (Step S3). Then, from among the obtained acceleration sensor values and the angular velocity sensor values, the trajectory creating unit 160 extracts a combination of the acceleration sensor value and the angular velocity sensor value measured at the same time (Step S4). The trajectory creating unit 160 converts the extracted acceleration sensor value and the angular velocity sensor value to the absolute coordinates (α and ω) (Step S5). After converting the values to the absolute coordinates, the trajectory creating unit 160 calculates the positions and the postures (R and P) by integrating the absolute coordinates in accordance with the boundary condition described above (Step S6).

After calculating the positions and the postures, the trajectory creating unit 160 determines whether the calculation of all of the positions and the postures of the acceleration sensor values and the angular velocity sensor values measured from the swing motion has been completed (Step S7). If the determination result is that the calculation of all of the positions and the postures of the acceleration sensor values and the angular velocity sensor values measured from the swing motion has not been completed (No at Step S7), the trajectory creating unit 160 performs the following process. Namely, by performing the processes at Steps S4 to S6 described above, the trajectory creating unit 160 calculates the positions and the postures of the acceleration sensor values and the angular velocity sensor values that have not been calculated.

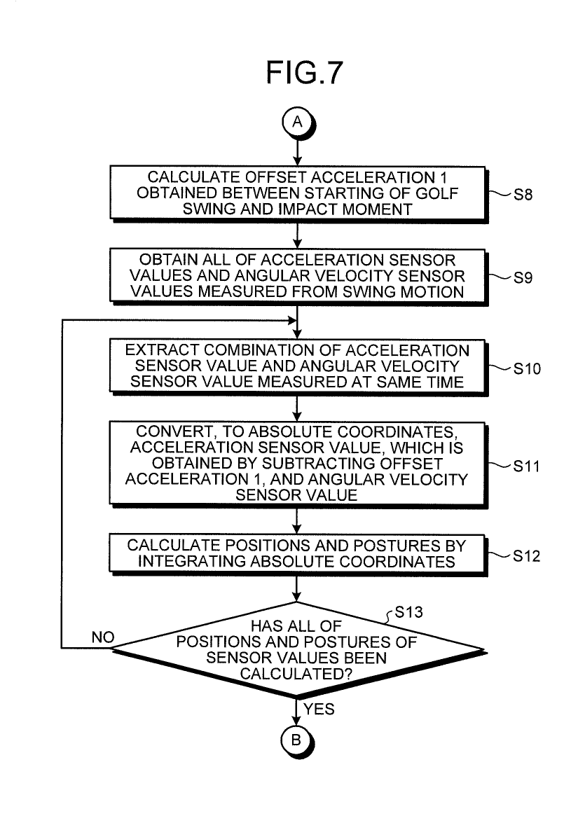

In contrast, if the calculation of all of the positions and the postures of the acceleration sensor values and the angular velocity sensor values measured from the swing motion has been completed (Yes at Step S7), the trajectory creating unit 160 performs the following process. Namely, as illustrated in FIG. 7, the trajectory creating unit 160 calculates the offset acceleration 1 obtained between the starting of the golf swing and the moment of the impact (Step S8).

After calculating the offset acceleration 1, the trajectory creating unit 160 performs basically the same processes as those performed at Steps S3 to S7 described above and calculates the corrected positions and the postures (R and P) that are associated between the starting of the swing and the moment of the impact and that are corrected in accordance with the offset acceleration 1.

Specifically, the trajectory creating unit 160 obtains, from the sensor value storing unit 140, all of the acceleration sensor values and the angular velocity sensor values measured from the swing motion (Step S9). Then, from among the obtained acceleration sensor values and the angular velocity sensor values, the trajectory creating unit 160 extracts a combination of the acceleration sensor value and the angular velocity sensor value measured at the same time (Step S10).

The trajectory creating unit 160 subtracts the offset acceleration 1 from the extracted acceleration sensor value and converts, to the absolute coordinates, the acceleration sensor value, which is obtained by subtracting the offset acceleration 1, and the angular velocity sensor value (Step S11). After converting the values to the absolute coordinates, the trajectory creating unit 160 calculates the positions and the postures (R and P) by integrating the absolute coordinates in accordance with the boundary conditions described above (Step S12).

After calculating the positions and the postures, the trajectory creating unit 160 determines whether the calculation of all of the positions and the postures of the acceleration sensor values and the angular velocity sensor values measured from the swing motion has been completed (Step S13). If the determination result is that the calculation of all of the positions and the postures of the acceleration sensor values and the angular velocity sensor values measured from the swing motion has not been completed (No at Step S13), the trajectory creating unit 160 performs the same processes as those performed at Steps S10 to S12 described above. Specifically, the trajectory creating unit 160 subtracts the offset acceleration 1 from each of the acceleration sensor values that have not been calculated and calculates the positions and the postures of the acceleration sensor value, which is obtained by subtracting the offset acceleration 1, and the angular velocity sensor value.

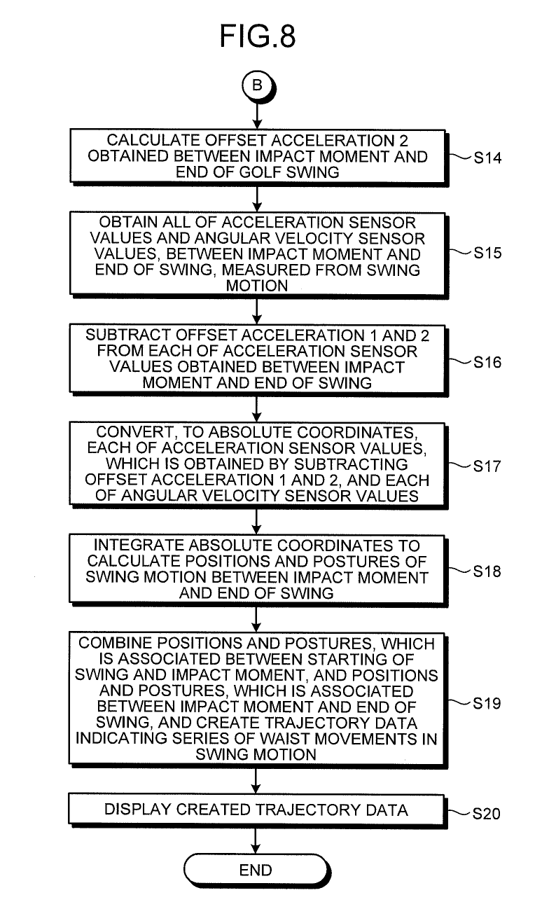

In contrast, if the calculation of all of the positions and the postures of the acceleration sensor values and the angular velocity sensor values measured from the swing motion has been completed (Yes at Step S13), the trajectory creating unit 160 performs the following process. Namely, as illustrated in FIG. 8, the trajectory creating unit 160 calculates the offset acceleration 2 obtained between the moment of the impact of the golf swing and the end of the swing (Step S14).

After calculating the offset acceleration 2, the trajectory creating unit 160 performs the same processes as those performed at Steps S9 to S12 described above and calculates the positions and postures (R and P) that are corrected in accordance with the offset acceleration 2 and that are associated between the moment of the impact and the end of the swing.

Specifically, the trajectory creating unit 160 obtains, from the sensor value storing unit 140, all of the acceleration sensor values and the angular velocity sensor values measured from the swing motion (Step S15). Then, the trajectory creating unit 160 subtracts the offset acceleration 1 and 2 from each of the acceleration sensor values obtained between the moment of the impact and the end of the swing (Step S16). The trajectory creating unit 160 converts, to the absolute coordinates, the acceleration sensor values, which are obtained by subtracting the offset acceleration 1 and 2, and the angular velocity sensor values (Step S17). After converting to the absolute coordinates, the trajectory creating unit 160 calculates the positions and the postures (R and P) by integrating the absolute coordinates in accordance with the boundary conditions described above (Step S18).

After calculating the position and posture, the trajectory creating unit 160 combines the positions and the postures, which are associated between the starting of the swing and the moment of the impact, and the positions and the postures, which are associated between the moment of the impact and the end of the swing, and creates the trajectory data indicating a series of waist movements in the swing motion (Step S19). Then, the trajectory creating unit 160 displays the created trajectory data on the display 130 (Step S20).

### Advantage of the Second Embodiment

As described above, according to the second embodiment, the mobile phone 100 calculates the offset acceleration generated during the golf swing by dividing a series of movements into two stages, i.e., between the starting of the golf swing and the impact and between the impact to the end of the golf swing. The mobile phone 100 subtracts the offset acceleration from the measured acceleration sensor value; performs the integration in accordance with the boundary conditions; and calculates the positions and the postures that are corrected by an amount of offset acceleration and that are obtained before and after the impact. Then, from the positions and the postures obtained from before and after the impact, the mobile phone 100 creates the motion trajectory of the waist obtained during the golf swing and displays it. According to the second embodiment, it is possible to take into consideration the impact that affects the trajectory of the predetermined region of the body, thus reproducing the motion trajectory of the waist obtained during the golf swing.

Furthermore, according to the second embodiment, the list of swing history data containing the date and time at which the motion trajectory of the waist is created is provided to a user; the data on the motion history of the waist associated with the date and time selected by the user is read from the trajectory data storing unit 150 and is output to the display 130. By doing so, it is possible to provide a motion trajectory in accordance with a request from a user.

In the second embodiment described above, a description has been given of a case of the mobile phone 100 by using, as an example, a golf swing as a series of movements; however, the embodiment is not limited to the golf swing. For example, it is also possible to use the measurement of movements including impact motion, such as a swing of a baseball bat.

### [c] Third Embodiment

### (1) Configuration of the Apparatus, Etc.

The components of each unit of the mobile phone 100 illustrated in FIG. 2 are only for conceptually illustrating the functions thereof and are not always physically configured as illustrated in the drawings. In other words, the specific shape of the separate or integrated mobile phone 100 is not limited to the drawings. For example, the trajectory creating unit 160 may be configured by functionally or physically separating into a position-and-posture calculating unit and a motion trajectory creating unit. In this way, all or part of the mobile phone 100 may be configured by functionally or physically separating or integrating any of the units depending on various loads or use conditions.

### (2) Trajectory Creating Program

Furthermore, various processes (see FIGS. 6 to 8) performed by the mobile phone 100 described in the embodiments may also be implemented by a program prepared in advance and executes by a computer, such as a personal computer or a workstation.

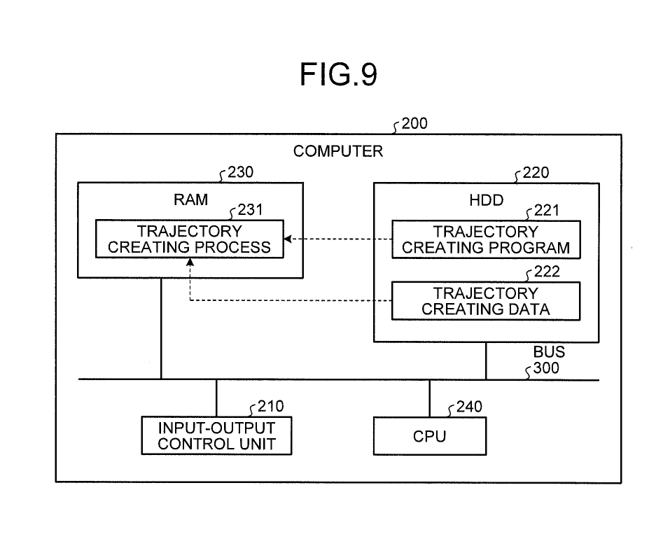

Accordingly, in the following, a computer that executes a trajectory creating program having the same function as the mobile phone 100 according to the above-described embodiments will be described with reference to FIG. 9. FIG. 9 is a block diagram illustrating a computer that executes a trajectory creating program.

As illustrated in FIG. 9, a computer 200 functioning as the mobile phone 100 includes an input-output control unit 210, an HDD 220, a RAM 230, and a CPU 240, which are connected via a bus 300.

The input-output control unit 210 controls an input and an output of the various kinds of information. The HDD 220 stores therein information needed for executing various processes performed by the CPU 240. The RAM 230 temporality stores therein various kinds of information. The CPU 240 executes various arithmetic processes.

As illustrated in FIG. 9, the HDD 220 stores therein, in advance, a trajectory creating program 221 and trajectory creating data 222 having the same function as that performed by the processing units in the mobile phone 100 illustrated in FIG. 2.

The trajectory creating program 221 may also appropriately be separated and be stored in a storing unit in another computer that is connected via a network.

Then, the CPU 240 reads the trajectory creating program 221 from the HDD 220 and loads it in the RAM 230, and thus the trajectory creating program 221 functions as a trajectory creating process 231, as illustrated in FIG. 9.

Specifically, the trajectory creating process 231 reads the trajectory creating data 222 and the like from the HDD 220 and loads, in an area of the RAM 230 allocated to the trajectory creating process 231, the trajectory creating data 222 and the like and executes various processes on the basis of the loaded data or the like.

Furthermore, the trajectory creating process 231 is particularly associated with the process performed by the trajectory creating unit 160 in the mobile phone 100 illustrated in FIG. 2.

The trajectory creating program 221 described above does not need to be stored in the HDD 220 from the beginning. For example, programs are stored in a “portable physical medium”, such as a flexible disk (FD), a CD-ROM, a DVD disk, a magneto-optic disk, an IC CARD, or the like that can be inserted in to the computer 200. Then, the computer 200 may read and execute the program from the flexible disk or the like described above.

Furthermore, the program may also be stored in another computer (or a server) connected to the computer 200 via a public circuit, the Internet, a LAN, a WAN, or the like. Then, the computer 200 may read and execute the program.

According to an aspect of the present invention, it is possible to accurately reproduce a trajectory of a series of movements.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium having stored therein a trajectory creating program causing a computer to execute a process comprising creating separately, if a series of movements has impact motion that generates a predetermined impact, by using sensor values obtained from an acceleration sensor and an angular velocity sensor that are attached to a predetermined region of a person's body, a motion trajectory of the predetermined region of the person's body that is obtained between the starting motion of the series of the movements and the impact motion and a motion trajectory of the predetermined region of the person's body obtained between the impact motion and the end motion of the series of the movements.

2. The non-transitory computer-readable storage medium according to claim 1, wherein the creating corrects the motion trajectory in accordance with
(a) a first condition in which the position and the posture of the predetermined region obtained immediately before the starting of the movements are the same as that obtained at the moment of the impact motion and
(b) a second condition in which a motion velocity of the predetermined region at the end of the movements is zero.

3. The non-transitory computer-readable storage medium according to claim 1, wherein the process further comprises:
storing, in a storing unit, data on the motion trajectory created at the creating by associating the data with a creation date and time;
providing, to a user, list information on the creation date and time associated with the data on the motion trajectory stored in the storing unit at the storing; and
reading, from the storing unit, the data on the motion trajectory associated with the creation date and time that is received from the user and that is in the list information provided at the providing if an input instruction of the creation date and time is received from the user; and
outputting the data on the read motion trajectory to a display unit.

4. A trajectory creating apparatus comprising a trajectory creating unit that separately creates, if a series of movements has impact motion that generates a predetermined impact, by using sensor values obtained from an acceleration sensor and an angular velocity sensor that are attached to a predetermined region of a person's body, a motion trajectory of the predetermined region of the person's body that is obtained between the starting motion of the series of the movements and the impact motion and a motion trajectory of the predetermined region of the person's body obtained between the impact motion and the end motion of the series of the movements.

5. A trajectory creating apparatus comprising:
a memory; and
a processor coupled to the memory, wherein the processor executes a process comprising:
creating separately, if a series of movements has impact motion that generates a predetermined impact, by using sensor values obtained from an acceleration sensor and an angular velocity sensor that are attached to a predetermined region of a person's body, a motion trajectory of the predetermined region of the person's body that is obtained between the starting motion of the series of the movements and the impact motion and a motion trajectory of the predetermined region of the person's body obtained between the impact motion and the end motion of the series of the movements
